(19) United States
(12) Patent Application Publication
(10) Pub. No.: US 2026/0012875 A1
(43) Pub. Date: Jan. 8, 2026

(54) SYSTEM AND METHOD FOR ROUTING SUBSCRIBER TRAFFIC

(71) Applicant: JIO PLATFORMS LIMITED, Ahmedabad (IN)

(72) Inventors: Sandeep BISHT, Kalyan Thane (IN); Anurag SINHA, Dombivali East (IN); Ezaj Ahmed ANSARI, Darjeeling, West Bengal (IN); Ravindra Kumar YADAV, New Rajendra Nagar (IN); Aayush BHATNAGAR, Navi Mumbai (IN)

(73) Assignee: JIO PLATFORMS LIMITED, Ahmedabad (IN)

(21) Appl. No.: 18/880,367

(22) PCT Filed: Mar. 11, 2024
(86) PCT No.: PCT/IN2024/050246

§ 371 Date: Dec. 31, 2024

(30) Foreign Application Priority Data
Mar. 29, 2023 (IN) 202321023226

(51) Int. Cl. H04W 40/02; H04L 45/302

(52) U.S. Cl. CPC H04W 40/02; H04L 45/302

(57) ABSTRACT

The disclosure discloses a method for routing subscriber traffic in a wireless network. The method comprising receiving one request at a service communication proxy (SCP) from at least one consumer node, determining if the received one request includes a subscription permanent identifier (SUPI) header. The method comprising extracting value of the SUPI header. The SUPI header includes a [symbol]
plurality of digits. The method comprising performing a modulo operation based on at least m number of digits of the SUPI header. The method comprising storing an index value corresponding to the at least m number of digits of the SUPI header in a memory. The method comprising calculating at least one network function instance value based on the stored index value and routing the received request to [symbol]
the calculated at least one network function instance to at least one provider node.

### RESERVATION OF RIGHTS

A portion of the disclosure of this patent document contains material, which is subject to intellectual property rights such as, but are not limited to, copyright, design, trademark, Integrated Circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF DISCLOSURE

The embodiments of the present disclosure generally relate to a field of subscriber traffic management. In particular, the present disclosure relates to a system and a method for routing subscriber traffic to a network function instance.

### BACKGROUND OF DISCLOSURE

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

Availability of fast and uninterrupted communication facilities has become imperative in today's high-tech world. Many communication devices such as smart phones, laptops, tablets, and the like, are there in the market for contending with the requirement of fast and uninterrupted communication facilities. These communication devices can be connected through various wired and wireless network technologies.

However, usage and number of communication devices are increasing day by day at an exponential rate, which has resulted in an increased [symbol] complexity of the existing networks. This may lead to poor service quality, [symbol] security,

[symbol]

[symbol]

and efficiency in the current communication networks. In such a scenario, a router acts as a primary control point, which aids in easing out the increasing complexities of the networks, provides reliable service quality and security, facilitates monitoring and improvement in efficiency, and other attributes that allow networks [symbol]
to add value. Therefore, by controlling a router, one can control, to a great extent, the corresponding network.

In general, routing may be defined as a mechanism of selecting a specific path in a network or between or across multiple networks for transmitting data quickly between a first communication device and a second communication device, which may be located remotely from each other. Routing may be performed on various networks including circuit-switched networks, for instance, public switched telephone network (PSTN), as well as computer networks, for instance, Internet.

In the routing process, routing tables are frequently used to direct the forwarding of data packets. Routing tables keep track of the paths to different network destinations. Routing tables can be created with the use of routing protocols, learned from network traffic, or may be provided by an administrator.

In general, next-generation based architecture, such as, 5G service-based architecture is designed in a way that all network functions are closely

[symbol]

interconnected. These network functions may possess the ability to discover the peer nodes and transmit network information among the nodes. This approach is bound to create a spaghetti of interconnections between several user devices, such as laptop, smartphone, tablet, and the like, connected through a network, which can hamper the flow of data between said user devices or may lead to loss of data. In [symbol]
certain scenarios, it may also lead to misplacement of data which is highly undesirable.

Conventional systems and methods are configured within a network that consists of several nodes, each having a distinct deployment scenario/architecture and functionality. Routing algorithms in the conventional systems and methods cannot manage distinct deployment scenarios/architectures and functionality of each node. Hence, the establishment of a communication

[symbol]

[symbol]

channel between the nodes may get affected, which may, in turn, adversely affect the flow of data in the network.

Further, with a handful of telecom operators, it is evident that each of the telecom operators have millions of unique customers i.e., unique subscribers.

Now, globally, as known in the art, there is a unique identifier assigned to each unique subscriber in the 5G domain, known as Subscription Permanent Identifier (hereafter, SUPI). The SUPI has been provisioned in the unified data management (UDM) or the unified data repository (UDR).

A SUPI may refer to a numerical string of 15 decimal digits. The first three digits represent the Mobile Country Code (MCC), the next two or three digits represent the Mobile Network Code (MNC) identifying the network operator, and the remaining digits represent the Mobile Subscriber Identification Number (MSIN) representing the subscriber identity for the network operator. Thus, the SUPI represents the individual user of that network operator. The SUPI is

[symbol]

equivalent to an International Mobile Subscriber Identity (IMSI) which uniquely identifies the Mobile Equipment (ME), which is also a string of 15 digits and used only within the 3^{rd} Generation Partnership Project (3GPP) system. The SUPI also contains the address of the home network to enable roaming scenarios. For interworking with the Evolved Packet Core (EPC), the SUPI allocated to a User Equipment (UE) is based on the IMSI. Therefore, with respect to the millions of unique customers for a telecom operator, millions of SUPIs also exist.

Further, at 5G nodes—Policy Control Function (PCF) and Charging Function (CHF), the sessions are created in multiple PCF and Charging Function Protocol Convertor (CHF-PC) instances for a unique SUPI. The CHF-PC acts a bridge to use the existing online charging system (OCS) in 5GC without support of HTTP/2 at OCS end. This results in an increase in the overall number of sessions at PCF and CHF-PC and ultimately creates an increased number of stale sessions and impacts the routing and related systems. As a result of this, it impacts the 5G service for that SUPI as well as other SUPIs and reduces the Key Performance Indicators (KPIs) significantly.

[symbol]

Due to such multiple session creation, several session limits at the CHF-PC are also exhausted or ended. For every subscriber, multiple Session Management (SM) sessions are created in parallel at different PCFs or network function (NF) instances. Additionally, for the same SUPI, multiple Spending Limit

[symbol]

Control Sessions are also seen at CHF clusters in parallel.

FIG. 1 illustrates a conventional subscriber traffic routing 100 as Service Communication Proxy (SCP) routing under Round-Robin Policy.

As conventionally known in the art, in a telecom network, a Session Management Function (SMF) 104 initially creates and sends a request to an NF

[symbol]

instance via a SCP proxy (102). The SMF (104) sends Npcf_SMPolicyControl_Create request to the SCP proxy (102) that further sends a Npcf_SMPolicyControl_Create request to the NF instance. The NF instance then creates and sends a response back to the SMF 104 corresponding to the request by the SMF 104, via the SCP 102. The NF instance sends Npcf_SMPolicyControl_Create response to the SCP proxy (102) that further sends Npcf_SMPolicyControl_Create response to the SMF (104). The NF instance may be a PCF or CHF-PC instance. A PCF instance is considered herein for reference.

For example, at a first instance (t=0, where ‘t’ is time), when a communication needs to establish by a user equipment with a telecom network, for

[symbol]

a SUPI, the SMF 104 creates and sends a first request to the PCF instance 1 via the SCP 102. The PCF instance 1 then creates and sends a first response back to the SMF 104 corresponding to the first request by the SMF 104, via the SCP 102. Further, at a next or following instance (t=n, where ‘n’ is a positive integer), for the said SUPI, the SMF 104 creates a second request and may send the second request to the PCF instance 1, or a new PCF instance 2 or n, via the SCP 102. Thus, the PCF instance 2 or n may also get involved for creating and sending a second response back to the SMF 104 corresponding to the second request by the SMF 104, via the SCP 102. Thus, in the Round-Robin Policy, there will always be multiple SM sessions in use for a single subscriber or a single SUPI.

Therefore, as shown in FIG. 1, according to the Round-Robin Policy, a SUPI instance may go to any another PCF instance, rather than going to the same

[symbol]

[symbol]

PCF instance. This creates multiple SM sessions and increases the overall number of sessions at PCF and/or CHF-PC nodes. As a result of this, an increased number of stale sessions are created in the Round-Robin Policy which impacts the 5G network service and reduces KPIs significantly.

Thus, at SCP, the mapping of SUPI sessions against the PCF instances becomes a resource intensive task, since there are millions of SUPI for a particular telecom operator.

This also results in memory overhead for the telecom system as well as network and the overhead of session eviction timers. There is session replication

[symbol]

between the high available pairs of the SCP.

There is, therefore, a need in the art to provide a method and a system for routing subscriber traffic from user equipment in a network that can overcome the shortcomings of the existing prior arts.

### SUMMARY

In an exemplary embodiment, the present invention discloses a method for routing subscriber traffic in a wireless network. The method comprising receiving, by a receiving unit, at least one request at a service communication proxy (SCP) from at least one consumer node. The method comprising determining, by a

[symbol]

processing unit, if the received at least one request includes a subscription permanent identifier (SUPI) header. The method comprising extracting, by the processing unit, a value of the SUPI header. The SUPI header includes a plurality of digits. The method comprising performing, by the processing unit, a modulo operation based on at least m number of digits of the SUPI header. The method comprising storing, by the processing unit, an index value corresponding to the at least m number of digits of the SUPI header in a memory. The method comprising calculating, by the processing unit, at least one network function instance value based on the stored index value. The method comprising routing, by a routing unit, the received request to the calculated at least one network function instance to at [symbol]
least one provider node.

[symbol]

In some embodiments, the modulo operation includes a precomputed modulo value stored in the memory.

In some embodiments, the index value is generated based on the modulo operation.

In some embodiments, a size of modulo (n) of the modulo operation is a number of the calculated network function instances.

In some embodiments, the at least m number of digits of the SUPI header are configurable by a user.

In an exemplary embodiment, the present invention discloses a system for routing subscriber traffic in a wireless network. The system comprising a receiving unit configured to receive at least one request at a service communication proxy (SCP) from at least one consumer node. The system comprising a processing unit configured to determine if the received at least one request includes a subscription permanent identifier (SUPI) header. The processing

[symbol]

unit configured to extract a value of the SUPI header. The SUPI header includes a plurality of digits. The processing unit is configured to perform a modulo operation based on at least m number of digits of the SUPI header. The processing unit configured to store an index value corresponding to the at least m number of digits of the SUPI header in a memory. The processing unit configured to calculate at [symbol]
least one network function instance value based on the stored index value. The system comprising a routing unit configured to route the received request to the calculated at least one network function instance to at least one provider node.

In some embodiments, the modulo operation includes a precomputed modulo value stored in the memory.

In some embodiments, the index value is generated based on the modulo operation.

In some embodiments, a size of modulo (n) of the modulo operation is the number of the calculated network function instances.

In some embodiments, the at least m number of digits of the SUPI header are configurable by a user.

[symbol]

In an exemplary embodiment, the present invention discloses a wireless network comprising a system for routing subscriber traffic. The system comprising a receiving unit configured to receive at least one request at a service communication proxy (SCP) from at least one consumer node. The system comprising a processing unit configured to determine if the received at least one request includes a subscription permanent identifier (SUPI) header. The processing unit configured to extract a value of the SUPI header. The SUPI header includes a plurality of digits. The processing unit is configured to perform a modulo operation based on at least m number of digits of the SUPI header. The processing unit

[symbol]

configured to store an index value corresponding to the at least m number of digits of the SUPI header in a memory. The processing unit configured to calculate at least one network function instance value based on the stored index value. The system comprising a routing unit configured to route the received request to the calculated at least one network function instance to at least one provider node.

In some embodiments, the modulo operation includes a precomputed modulo value stored in the memory.

In some embodiments, the index value is generated based on the modulo operation.

### OBJECTS OF THE PRESENT DISCLOSURE

Some of the objects of the present disclosure, which at least one embodiment herein satisfies are as listed herein below.

An object of the present disclosure is to provide a system and a method for routing subscriber traffic from user equipment(s) in a network.

An object of the present disclosure is to provide a system and a method for routing subscriber traffic through the same Policy Control Function (PCF) or Charging Function-Protocol Converter (CHF-PC) session for a single Subscription Permanent Identifier (SUPI) or a subscriber.

An object of the present disclosure is to improve the user experience by providing fast and secured data interaction in a network.

An object of the present disclosure is to provide a system and a method that automatically improves the optimization of resources in a network.

An object of the present disclosure is to provide a system and a method for enhanced processing speeds for incoming subscriber traffic in a

[symbol]

network.

An object of the present disclosure is to provide a system and a method for routing subscriber traffic in a network with reduced memory space and usage.

Another object of the present disclosure is to provide a system and a method for routing subscriber traffic that may enable the communication with an optimized routing solution.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components or circuitry commonly used to implement such components.

FIG. 1 illustrates subscriber traffic routing 100 as Service Communication Proxy (SCP) routing under Round-Robin Policy.

FIGS. 2A-2B illustrate exemplary representations (200, 250) of system architecture of SCP, in accordance with embodiments of the present disclosure.

FIG. 3 illustrates an exemplary flow chart 300 of a method for routing subscriber traffic, in accordance with an embodiment of the present disclosure.

[symbol]

FIG. 4 illustrates an exemplary representation 400 for routing subscriber traffic in which or with which embodiments of the present disclosure may be implemented.

FIG. 5 illustrates an exemplary overview 500 of SCP deployment based on 5G functionality in independent deployment units, in accordance with an embodiment of the present disclosure.

FIG. 6 illustrates an exemplary representation 600 showing an integrated implementation including various routing policies, in accordance with an embodiment of the present disclosure.

FIG. 7 illustrates an exemplary computer system 700 in which or with which embodiments of the present disclosure may be implemented.

FIG. 8 illustrates an exemplary flow diagram for a method for routing subscriber traffic in a wireless network.

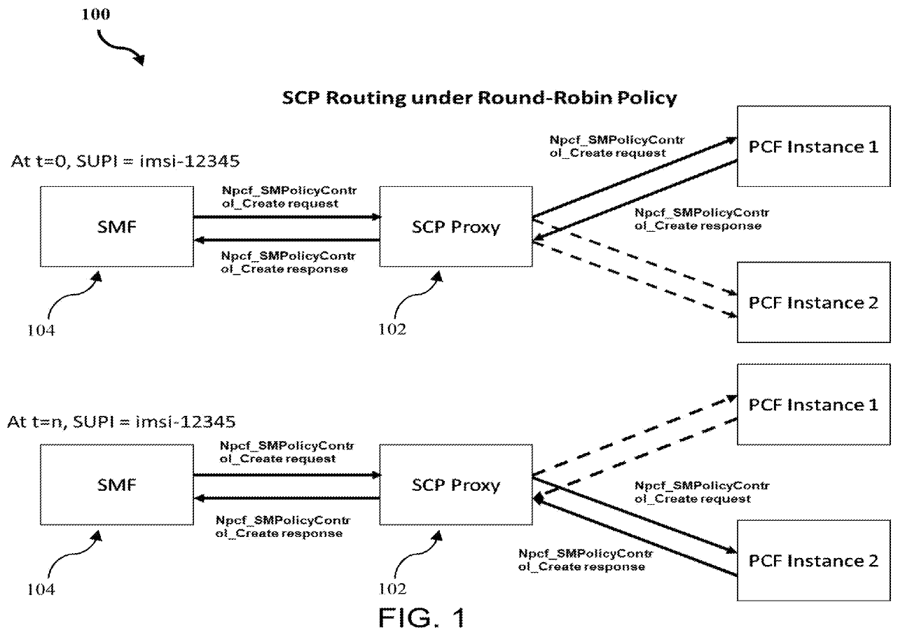

The foregoing shall be more apparent from the following more detailed description of the disclosure.

### LIST OF REFERENCE NUMERALS

100—Service communication proxy (SCP) routing under Round-Robin Policy
102, 204, 402—Service communication proxy (SCP)
104, 404—Session management function (SMF)
200, 250—A system architecture of SCP
202—SCP controller/processor
206—Memory
208—Interface(s)
210—Processing unit
212—Receiving unit
214—Proxy information module
216—Routing unit
218—Other unit(s)
220—Database
300—Flowchart
400—SCP routing based on present invention
500—Overview of SCP deployment based on 5G functionality
600—An integrated implementation including various routing policies
700—A computer system
710—External storage device
720—Bus
730—Main memory
740—Read only memory
750—Mass storage device
760—Communication port(s)
770—Processor
800—Flow Diagram

### DETAILED DESCRIPTION OF DISCLOSURE

In the following description, for the purposes of explanation, various specific details are set forth in order to provide a thorough understanding of

[symbol]

embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure.

Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to

[symbol]

obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a

[symbol]

procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is [symbol] not

[symbol]

[symbol]

necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed [symbol]
description or the claims, such terms are intended to be inclusive in a manner similar to the term “comprising” as an open transition word without precluding any additional or other elements.

Reference throughout this specification to “one embodiment” or “an embodiment” or “an instance” or “one instance” means that a particular feature,

[symbol]

structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined [symbol]
in any suitable manner in one or more embodiments.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further

[symbol]

understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations [symbol]
of one or more of the associated listed items.

Certain terms and phrases have been used throughout the disclosure and will have the following meanings in the context of the ongoing disclosure.

The term “telecom network” or “network” may refer to a computing environment in which physical objects are embedded with devices which enable the

[symbol]

physical objects to achieve greater value and service by exchanging data with other systems and/or other connected devices. Each physical object is uniquely [symbol] [symbol]
identifiable through its embedded device(s) and is able to interoperate within an Internet infrastructure.

The term “real time” may refer to a level of processing responsiveness that a user or system senses as sufficiently immediate for a particular process or determination to be made, or that enables a processor to keep up with some external process.

The term “automatically” may refer to without user intervention.

The term “Subscription Permanent Identifier” may refer to a unique identification of a user of a telecom network or a telecom operator termed as a

[symbol]

“subscriber.” The acronym “SUPI,” as used herein, means “Subscription Permanent Identifier.”

As used in the present disclosure, the following terms are generally intended to have the meaning as set forth below, except to the extent that the context in which they are used to indicate otherwise.

The term SUPI as used herein, refers to subscription permanent identifier. The SUPI is a globally unique identifier that is assigned to each subscriber in the 5G system.

The term UDM as used herein, refers to unified data management. The UDM manages network user data in a single and centralized element.

The term UDR as used herein, refers to unified data repository. The UDR stores and retrieves the subscription data.

The term PCF as used herein, refers to Policy Control Function. The PCF provides policy rules for control plane functions. This includes network slicing, roaming and mobility management.

The term SMF as used herein, refers to Session Management Function. The SMF is primarily responsible for interacting with the decoupled data plane, creating, updating, and removing protocol data unit (PDU) sessions and managing session context with the user plane function (UPF).

The term SCP as used herein, refers to Service Communication Proxy. The SCP is a new HTTP/2 based network function enabling dynamic scaling and management of communication and services in the 5G network.

[symbol]

The term EMS as used herein, refers to element management system. The EMS consists of systems and applications for managing network elements (NE) on the network element-management layer (NEL) of the Telecommunications Management Network (TMN) model.

The term AMF as used herein, refers to access and mobility management function. The AMF is responsible for managing access and mobility for 5G devices, and it interacts with other network functions such as the UPF (User Plane Function), SMF (Session Management Function), and AUSF (Authentication Server Function).

The term UCMF as used herein, refers to a UE capability management function. The UCMF is a standard 3GPP entity responsible for storing capability dictionary of the connected user equipment and provides the information to other functions in the network.

The term SMSF as used herein, refers to short message service function. The SMSF is responsible for the transmission of SMS messages between users and devices in the 5G network and those in other networks (2G/3G/4G).

The term EIR as used herein, refers to equipment identity register. The EIR is a network entity that stores lists of international mobile equipment identity (IMEI) numbers, which correspond to physical handsets (not subscribers).

The term AUSF as used herein, refers to authentication server function (AUSF). The AUSF performs 5G authentication and key agreement method 5G AKA.

The term SEPP as used herein, refers to security edge protection proxy. The SEPP enables secure interconnect between 5G networks.

The term BSF as used herein, refers to binding support function. The BSF allows policy control function (PCF) to register, update, and remove the binding information from it, and allows network function (NF) consumers to discover the selected PCF.

The term NEF as used herein, refers to network exposure function. The NEF enables the external application administrators to customize the network for providing innovative services to their end-users.

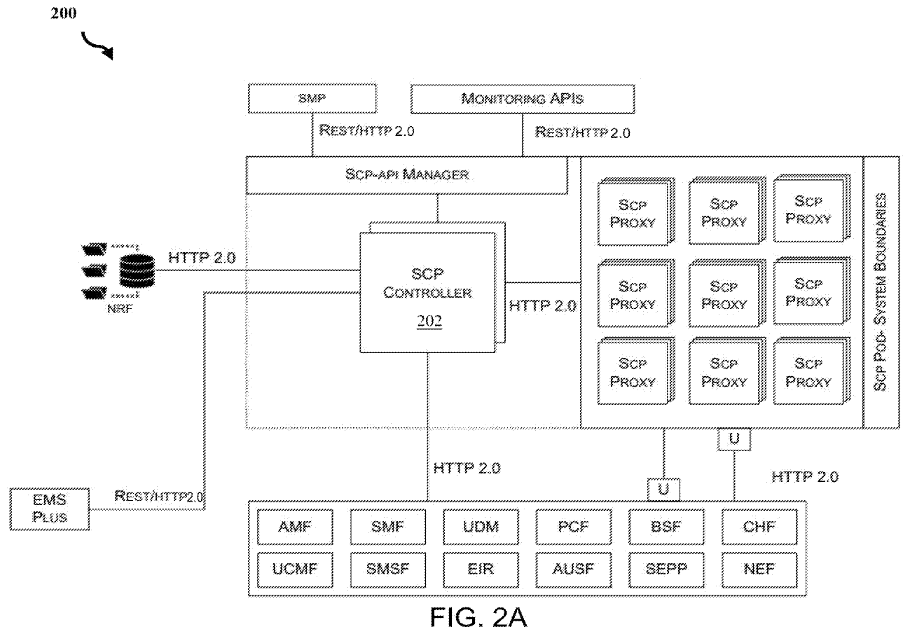

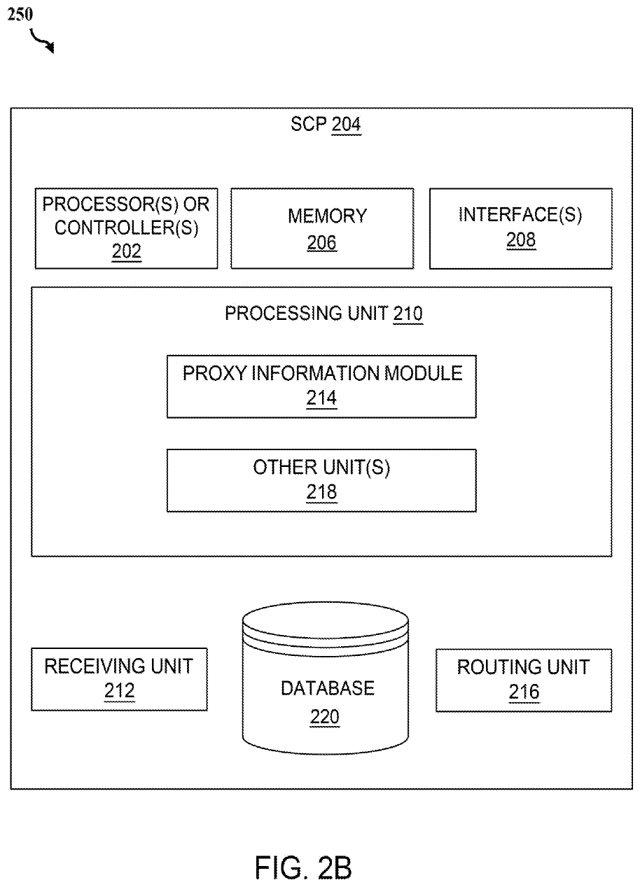

The various embodiments throughout the disclosure will be explained in more detail with reference to FIGS. 2A-7.

FIGS. 2A-2B illustrate exemplary representations (200, 250) of system architecture of service communication proxy (SCP), in accordance with embodiments of the present disclosure.

Referring to FIG. 2A, point-of-delivery (POD) may be outlined by the dashed lines and alongside are the system boundaries of the SCP. All the other systems/components may be 3GPP defined 5G Network Functions (NF) which may include protocol interfaces with the SCP.

In an embodiment, the architecture of SCP may include at least one of the following functionalities:
Indirect communication
Delegated discovery
Message forwarding and routing to destination NF/NF service
Communication security (e.g., authorization of the NF service consumer to access the NF service producer application programming interface (API)), load balancing, monitoring, overload control, etc.
Optionally, interact with unified data repository (UDR), to resolve the unified data management (UDM) group identity (ID)/UDR group ID/authentication server function (AUSF) group ID/policy control function (PCF) group ID/charging function (CHF) group ID/home subscriber server (HSS) group ID based on user equipment (UE) identity, e.g., SUPI or Internet [symbol]
   protocol multimedia private identity (IMPI)/IP multimedia public identity (IMPU).

In an embodiment, the proposed SCP may include a SCP proxy along with a SCP controller 202. In an embodiment, the SCP proxy may be either ingress proxy or egress proxy, wherein:
Ingress proxy: This proxy instance ensures incoming traffic for producer NF based on configured policy default is round robin. [symbol]
Egress Proxy: This proxy instance ensures consumer's outgoing traffic flow to a right SCP ingress proxy, and routing based on NF or SCP selection criteria.

It may be appreciated that a hybrid deployment is also possible where a single SCP instance may act as egress as well as ingress proxy.

In an embodiment, the SCP may include multiple SCP proxies as shown in FIG. 2A, which may be communicatively linked to the SCP controller 202 along with network repository function (NRF), element management system (EMS) plus, systems management protocol (SMP), APIs, and various NFs via a hypertext transfer protocol 2.0 (HTTP 2.0) module. Further, the SCP controller 202 may be configured to manage all SCP proxy instances and select appropriate proxy instance as egress or ingress for target NFs during NF registration and discovery flow, and in order to do so, the SCP controller 202 may need to deploy in front of NRF clusters serving for multiple public land mobile network (PLMN) or single

[symbol]

PLMN. In an exemplary embodiment, the SCP controller 202 may configure some instances of PLMN to act as a disaster recovery (DR) endpoint for corresponding set of active PLMN cluster endpoints.

In an embodiment, and as shown in FIG. 2B, an example block diagram representation 250 of the SCP 204 is shown. The SCP 204 may facilitate routing of requests by a combination of hardware and software implementation. FIG. 2B illustrates an exemplary representation of the SCP 204, in accordance with an embodiment of the present disclosure. The SCP 204 may include one or more processors or controllers (for example, SCP controller 202 as shown in FIG. 2A). The one or more processor(s) or controller(s) 202 may be coupled with a memory

[symbol]

206. The memory 206 may store instructions which when executed by the one or more processors or controller(s) 202 may cause the SCP 204 to perform the steps as described herein.

In an embodiment, the SCP 204 includes a receiving unit 212 and a routing unit 216. The receiving unit 212 configured to receive at least one request at a service communication proxy (SCP) from at least one consumer node. The consumer node pertain to a user device sending the request.

[symbol]

In an embodiment, the SCP 204 includes a processing unit 210. The processing unit 210 is configured to determine if the received at least one request includes a subscription permanent identifier (SUPI) header. The processing unit configured to extract a value of the SUPI header. The SUPI header includes a

[symbol]

plurality of digits. The processing unit is configured to perform a modulo operation based on at least m number of digits of the SUPI header. The processing unit configured to store an index value corresponding to the at least m number of digits of the SUPI header in a memory. The index value is generated based on the modulo operation. The processing unit configured to calculate at least one network function [symbol]
instance value based on the stored index value.

In an embodiment, the SCP 204 includes a routing unit configured to route the received request to the calculated at least one network function instance to at least one provider node.

In an embodiment, the processor(s) or controller(s) 202 may enable routing of requests from a consumer node (pertaining to a user device sending the request) to a destination mode (or provider node). For example, the processor(s) or controller(s) 202 may identify/configure at least one endpoint or node, prior to routing the request. In this example, the identification of available endpoints in a cluster of endpoints may be done, wherein the cluster may pertain to, for example, an active cluster and a DR cluster. In an example embodiment, the request may be routed to the identified/configured pair if at least one endpoint in the pair may be functional. The active cluster may include active endpoints to which request may be preferably routed if the endpoint may be available. The DR cluster may include DR endpoints, wherein the DR endpoints may be considered an alternative endpoint

[symbol]

for routing the request if the corresponding active endpoint may be un-available or non-functional. In an example embodiment, as per the active-standby policy, the endpoints in the active and DR clusters may be paired to form a pair of endpoints. The pairwise configuration/identification may be performed prior to the routing, which may enable effective management of the incoming requests. This may also enable to pre-plan the routing directly to DR endpoint (in the DR cluster) if the corresponding active endpoint (in active cluster) may be unavailable. In an alternate [symbol] [symbol]
embodiment, multiple endpoints in active cluster may be paired to a single DR endpoint.

In an example embodiment, the identification/configuration of pair of endpoints may be performed based on pre-defined policy of the SCP 204. For example, the pre-defined policy may pertain to active standby implementation, which is explained herein. For example, the processor(s) or controller(s) 202 may evaluate when an endpoint of the active cluster, for example, a first endpoint is unavailable and may be able to configure a corresponding endpoint in DR cluster, prior to routing the request. In another example, the processor(s) or controller(s) 202 may evaluate when an endpoint, for example, a first endpoint of an active cluster is unavailable and also may be able to also evaluate if the corresponding DR endpoint (second endpoint) pertaining to the first endpoint is unavailable so that the request may not be routed at all to the first endpoint. This may save unnecessary re-routing and may also facilitate effective routing steps. In an example embodiment,

[symbol]

the identification/configuration of pair of endpoints may be performed based on a pre-defined criterion. For example, the pre-defined criteria may pertain to, for example, header routing criteria, which may enable the processor(s) or controller(s) 202 to decide which endpoints to be selected (prior to routing) based on the availability. Various other examples are provided in the following sections, [symbol]
although the present disclosure may not be limited by these examples. In an example, the header routing criteria may include, but not limited to, at least one of:
a) 3gpp-sbi-discovery/3gpp-sbi-discovery-nf-id
b) 3gpp-sbi-target-apiroot
c) 3gpp-sbi-binding/3gpp-sbi-routing-binding

In an example embodiment, if multiple pre-defined criteria or header routing criteria may be considered, the processor(s) or controller(s) 202 may be able to prioritize the pre-defined criteria to enable appropriate selection/identification/configuration of endpoints prior to routing of the request. Various other embodiments may be possible.

The SCP implementation may pertain to ingress node and/or egress node. In case of ingress node implementation, the NF profile used for registration

[symbol]

[symbol]

may include multiple of two endpoints and in correct sequence. In an example embodiment, 0-based indexing may be used such that endpoint at even index should belong to active cluster while odd index should belong to DR cluster.

In an embodiment, the processor(s) or controller(s) 202 may be implemented as one or more microprocessors, microcomputers, microcontrollers, digital signal processors, central processing units, logic circuitries, and/or any devices that process data based on operational instructions. Among other capabilities, the processor(s) or controller(s) 202 may be configured to fetch and execute computer-readable instructions stored in the memory 206 of the SCP 204. The memory 206 may be configured to store one or more computer-readable instructions or routines in a non-transitory computer readable storage medium, which may be fetched and executed to create or share data packets over a network service. The memory 206 may comprise any non-transitory storage device including, for example, volatile memory such as random-access memory (RAM), or non-volatile memory such as erasable programmable read-only memory (EPROM), flash memory, and the like.

In an embodiment, the SCP 204 may include an interface(s) 208. The interface(s) 208 may comprise a variety of interfaces, for example, interfaces for data input and output devices, referred to as I/O devices, storage devices, and the

[symbol]

like. The interface(s) 208 may facilitate communication of the SCP 204. The interface(s) 208 may also provide a communication pathway for one or more components of the SCP 204. Examples of such components include, but are not limited to, processing unit 210 and a database 220.

The processing unit 210 may be implemented as a combination of hardware and programming (for example, programmable instructions) to implement one or more functionalities of the processing unit 210. In examples described herein, such combinations of hardware and programming may be implemented in several different ways. For example, the programming for the processing unit 210 may be processor-executable instructions stored on a non-transitory machine-readable storage medium and the hardware for the processing unit 210 may comprise a processing resource (for example, one or more

[symbol]

[symbol]

processors), to execute such instructions. In the present examples, the machine-readable storage medium may store instructions that, when executed by the processing resource, implement the processing unit 210. In such examples, the SCP 204 may comprise the machine-readable storage medium storing the instructions [symbol]
and the processing resource to execute the instructions, or the machine-readable storage medium may be separate but accessible to the SCP 204 and the processing resource. In other examples, the processing unit 210 may be implemented by electronic circuitry.

In an embodiment, the processor(s) or controller(s) 202 may pertain to an ingress controller to enable processing/controlling one or more aspects of received incoming request at an ingress node (entry point) of SCP 204. In another embodiment, the processor(s) or controller(s) 202 may pertain to an egress controller to enable processing/controlling one or more aspects of request that are being routed at an egress node (exit point) of SCP 204. In yet another embodiment,

[symbol]

the processor(s) or controller(s) 202 may pertain to an integrated controller including both ingress and egress controller to enable processing/controlling one or more aspects of received incoming request at an ingress node (entry point) of SCP 204 and/or to enable processing/controlling one or more aspects of request that are being routed at an egress node (exit point) of SCP 204.

The processing unit 210 may include one or more components (as shown in FIG. 2B) including proxy information module 214, and other modules or components 218. The proxy information module 214 may enable to collect or store an information pertaining to available proxy or endpoints pertaining to active and/or DR cluster. The other modules or components 218 may include, but not limited to,

[symbol]

ingress module (pertaining to ingress node), egress module (pertaining to egress node), load balancer, edge router configuration module, mapping module (to map endpoints pertaining to active and/or DR cluster), request processing module, error message generation module and other modules or engines. Various other functions of the components may be possible. In an embodiment, the database 220 may [symbol]
comprise data that may be either stored or generated as a result of functionalities implemented by any of the components of the processing unit 210.

[symbol]

In an aspect, the SCP 204 may not only ease in resolution of the challenges in the next generation-based architecture, such as, for example 5G service-based architecture, but may also optimize subscriber traffic routing which may result in providing enhanced performance of the core network. The SCP 204 may also boost the network performance by continuously coordinating with other network functions in an efficient and improved manner.

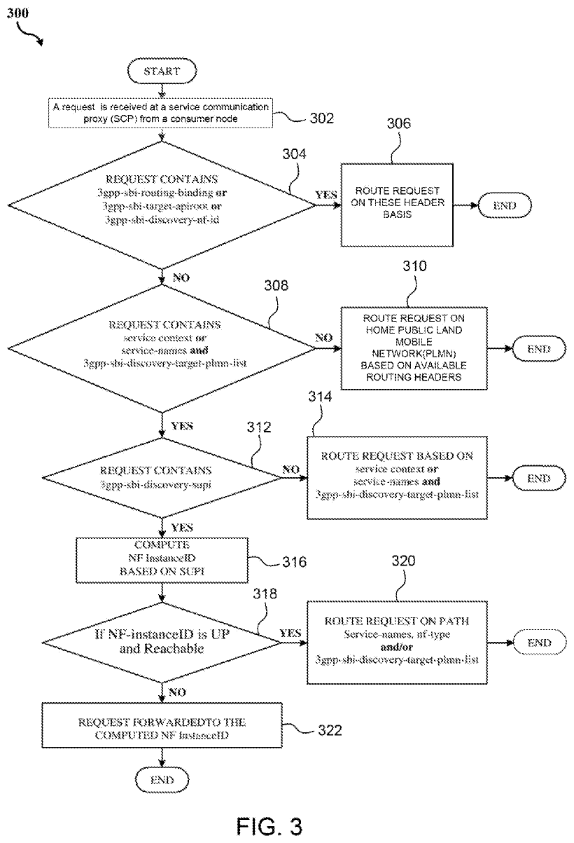

FIG. 3 illustrates an exemplary flow chart 300 of a method for routing subscriber traffic, in accordance with an embodiment of the present disclosure.

Referring to FIG. 3, according to a method for routing subscriber traffic, at SCP, the 5G routing proxy maintains a pre-computed modulo value in the cache (i.e., Random Access Memory), to minimise time consumption for modulo computation.

At step 302, a request is received at a service communication proxy (SCP) from a consumer node.

At step 304, it is determined whether the request contains headers “3gpp-sbi-routing-binding” or “3gpp-sbi-target-apiroot” or “3gpp-sbi-discovery-nf-id”.

At step 306, if the request contains the header “3gpp-sbi-routing-binding” or “3gpp-sbi-target-apiroot” or “3gpp-sbi-discovery-nf-id”, the request is routed based on these headers.

At step 308, if the request does not contain the header “3gpp-sbi-routing-binding” or “3gpp-sbi-target-apiroot” or “3gpp-sbi-discovery-nf-id” it is determined whether the request contains header “service context” or “service-names” and “3gpp-sbi-discovery-target-plmn-list”.

At step 310, when the request does not contain header “service context” or “service-names” and “3gpp-sbi-discovery-target-plmn-list”, the request is routed on home-public land mobile network (PLMN) based on the available headers. The service context happens from the step 310.

At step 312, when the request contains header “service context” or “service-names” and “3gpp-sbi-discovery-target-plmn-list”, it is determined whether the request contains “3 gpp-sbi-discovery-supi”.

At step 314, when the request does not contain “3gpp-sbi-discovery-supi”, the request is routed based on “service context” or “service-names” and “3gpp-sbi-discovery-target-plmn-list”.

At step 316, when the request contains “3gpp-sbi-discovery-supi” a NF instance ID is computed based on SUPI.

At step 318, it is determined if NF-instance ID is UP and reachable.

At step 320, when the NF-instance ID is UP and reachable, the request is routed on path “Service-names, nf-type and/or 3gpp-sbi-discovery-target-plmn-list. The ‘UP’ is a state when the NF is up and running properly on server and ‘reachable’ is a state that means that a connectivity is available between the NF and the SCP.

At step 322, when the NF-instance ID is not UP and not reachable, the request is forwarded to the computed NF instance ID.

[symbol] . Briefly, when a first session for a SUPI is created at a PCF or Charging Function-Policy Converter (CHF-PC) cluster/instance in a load balanced manner for said SUPI, if said SUPI is not present in the telecom network, then

[symbol]

forwarding all the following SUPI sessions for the said SUPI or subscriber to the same PCF or CHF-PC cluster/instance may be termed as modulo-based routing.

Further, the size of the pre-computed modulo (n) is the number of NF instances. The size of the pre-computed modulo (n) may be static configured or dynamically changed via SCP command line interface (CLI).

When a request is received at SCP and if the request contains a SUPI (3gpp-sbi-discovery-supi) header, then the value of the SUPI header is extracted. The last five digits of SUPI (3gpp-sbi-discovery-supi) header value are used for performing modulo operation.

After performing modulo operation, the SCP finds a value against the last five digits of SUPI (3gpp-sbi-discovery-supi) header value in a cache memory (i.e., Random Access Memory). The value against the last five digits of

[symbol]

[symbol]

SUPI (3gpp-sbi-discovery-supi) header value is stored as a natural number in the cache memory, which is number in the range of 0 to ‘n’ (natural number).

The natural number value stored in the cache memory is known as an index, which may be configured to give the NF instance value (nf-instance or NF Instance ID as shown in FIG. 3).

At last, if the NF instance value (nf-instance or NF Instance ID) is reachable for the SCP in a session management (SM) session, the request is then forwarded on the given NF instance value (nf-instance or NF Instance ID).

In an aspect of the present disclosure, the last five SUPI (3gpp-sbi-discovery-supi) header may be configurable by a user of a system for routing subscriber traffic, in accordance with embodiments of the present disclosure.

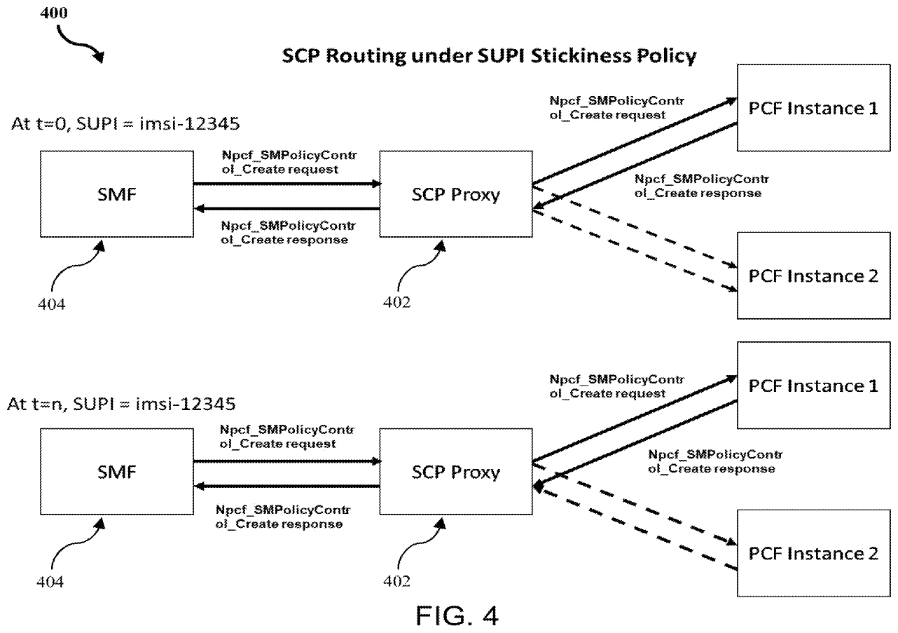

FIG. 4 illustrates a system 400 for routing subscriber traffic in which or with which embodiments of the present disclosure may be implemented.

Referring to FIG. 4, in a telecom network, a Session Management

[symbol]

[symbol]

Function (SMF) 404 initially creates and sends a request to a NF instance via a SCP 402. The NF instance then creates and sends a response back to the SMF 404 corresponding to the request by the SMF 404, via the SCP 402. The NF instance may be a PCF or CHF-PC instance. A PCF instance is considered herein for reference.

For example, at a first instance (t=0, where ‘t’ is time), when a communication needs to establish by a user equipment with a telecom network, for a SUPI, the SMF 404 creates and sends a first request to the PCF instance 1 via the SCP 402. The SMF (104) sends Npcf_SMPolicyControl_Create request to the SCP proxy (102) that further sends a Npcf_SMPolicyControl_Create request to the PCF

[symbol]

instance 1. The Npcf_SMPolicyControl_Create request creates an SM Policy association with the PCF to receive the policy for a PDU session. The PCF instance 1 then creates and sends a first response back to the SMF 404 corresponding to the first request by the SMF 404, via the SCP 402. The PCF instance 1 sends Npcf_SMPolicyControl_Create response to the SCP proxy (102) that further sends [symbol]
Npcf_SMPolicyControl_Create response to the SMF (104). Further, at a next or following instance (t=n, where ‘n’ is a positive integer), for the said SUPI, the [symbol] [symbol]
SMF 404 creates a second request and sends the second request to the said PCF instance 1, via the SCP 402. Thus, the PCF instance 2 or n do not involve in the process of creating and sending a second response back to the SMF 404 corresponding to the second request by the SMF 404, via the SCP 402, as seen in the conventional art. Thus, there are no multiple SM sessions in use for a single subscriber or a single SUPI, as there will always be only a single and unique SM session for each subscriber or a single SUPI.

Further, the aforementioned solution provides that the first session for a SUPI is created at a PCF or CHF-PC cluster/instance in a load balanced manner for the said SUPI if the said SUPI is not present in the telecom network, and then all following SUPI sessions for the said SUPI or subscriber are forwarded to the same PCF or CHF-PC cluster/instance. This may also be termed as modulo based routing.

In an embodiment, a UE associated with a subscriber may include, but is not limited to, a handheld wireless communication device (e.g., a mobile phone, a smart phone, a phablet device, and so on), a wearable computer device (e.g., a head-mounted display computer device, a head-mounted camera device, a wristwatch computer device, and so on), a Global Positioning System (GPS) device, a laptop computer, a tablet computer, or another type of portable computer, a media

[symbol]

playing device, a portable gaming system, and/or any other type of computer device with wireless communication capabilities, and the like. In an embodiment, the UE may include, but is not limited to, any electrical, electronic, electro-mechanical, or an equipment, or a combination of one or more of the above devices such as virtual reality (VR) devices, augmented reality (AR) devices, laptop, a general-purpose [symbol]
computer, desktop, personal digital assistant, tablet computer, mainframe computer, or any other computing device, wherein the UE may include one or more in-built or externally coupled accessories including, but not limited to, a visual aid device such as camera, audio aid, a microphone, a keyboard, and input devices for receiving input from a user or subscriber such as touch pad, touch enabled screen, [symbol]
electronic pen, and the like. A person of ordinary skill in the art will appreciate that [symbol] [symbol]
the UEs may not be restricted to the mentioned devices and various other devices may be used.

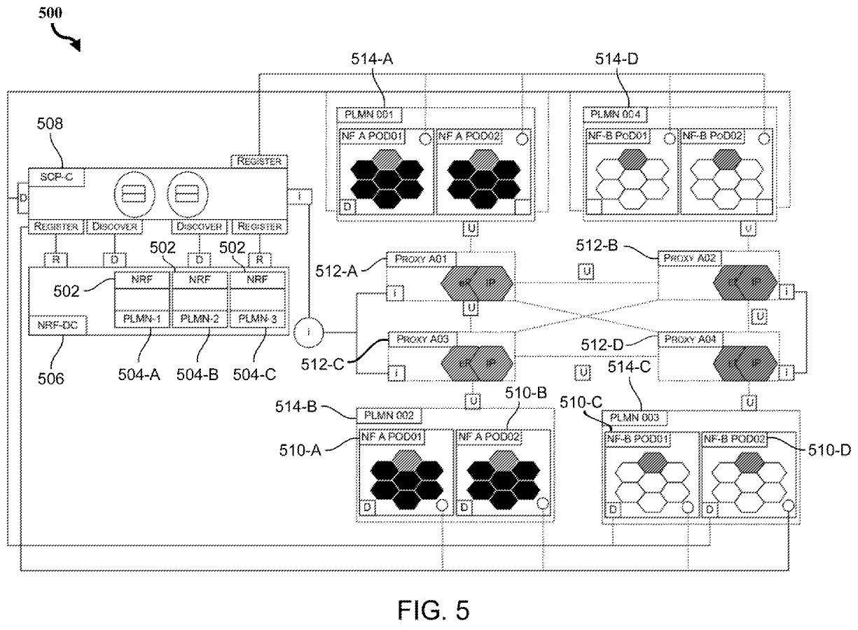

FIG. 5 illustrates an exemplary overview 500 of SCP deployment based on the 5G functionality and SCP being deployed in independent deployment units, in accordance with an embodiment of the present disclosure.

Referring to FIG. 5, an overview of SCP deployment is illustrated, the SCP deployment may be based on the 5G functionality and SCP may be deployed in independent deployment units. Further, the system may be designed in a way that it may support:
One SCP proxy instance for single NF type considered for one PLMN,
One SCP proxy instance for multiple NF type considered for one PLMN,
One SCP proxy instance for multiple NF type considered for multiple PLMN,
Multiple proxies in single PLMN for multiple NF types, and
Single SCP controller for multiple NRF instances considered for multiple PLMN.

In an embodiment, the system may be configured to provide different types of routing techniques for an SCP proxy, where the routing techniques may be implemented as per requirement of different NF team and their GR/DR handling. In one embodiment, ingress active standby routing technique may be used at an ingress proxy whereas the egress active standby routing technique may be used at an egress proxy. In these routing technique, GR or DR cluster may

[symbol]

be defined based upon PLMN-list. In an example, the proposed active standby routing technique may also be integrated with other policies, such as, Active-Active routing policy, which may ensure utilizations of all endpoints in active cluster first.

In an embodiment, the is SCP controller (508) may be configured to manage all SCP proxy (512) instances and select appropriate proxy instance as

[symbol]

[symbol]

egress or ingress for target network functions (NFs) (e.g., NF-A, NF-B) (510) during NF registration and discovery flow.

[symbol]

In an embodiment, the SCP controller may be deployed in front of the network repository function (NRF) (502, 506) clusters serving for multiple public land mobile network (PLMN) (504-A, 504-B, 504-C).

In an embodiment the NF-A (510-A) and NF-B (510-B) may be a PCF, a CHF, or an AMF.

In an embodiment, PLMN 001 (514-A), PLMN 002 (514-B), PLMN 003 (514-C) and PLMN 004 (514-D) may be PLMN code which is part of the standard. The PLMN 001 (514-A), PLMN 002 (514-B), PLMN 003 (514-C) and PLMN 004 (514-D) may contain information of a mobile country code and a mobile network code.

In an embodiment, the NF (510) registration/discovery requests may be sent to the NRF (502) via the SCP controller (508). The NF may include NF-A (510-A) and NF-B (510-B).

In an embodiment, the service requests may be sent from consumer NF to egress proxy and egress proxy forwards the service request to the ingress proxy. The ingress proxy may send the service request to the producer NF.

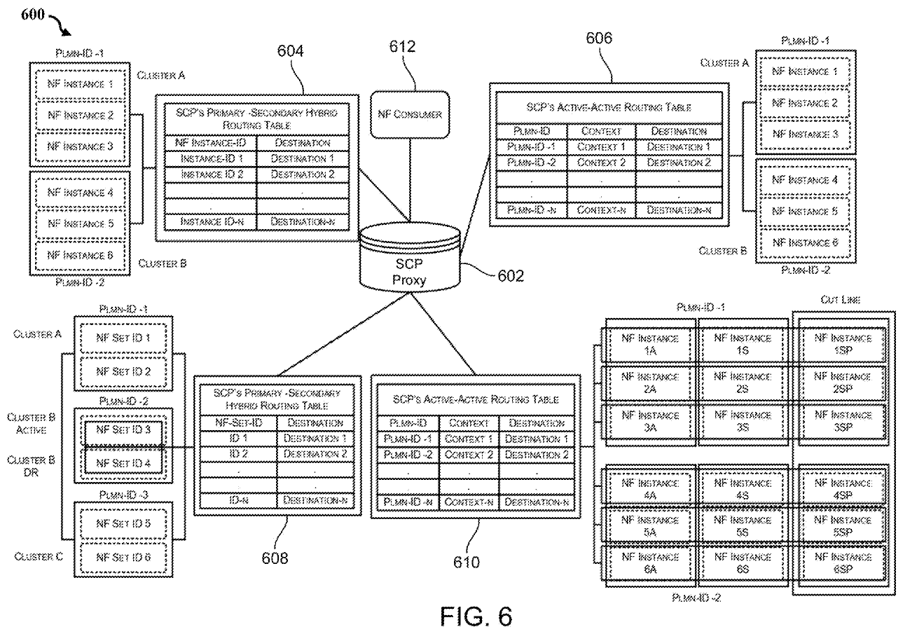

FIG. 6 illustrates exemplary representation 600 showing an integrated implementation including various routing policies, in accordance with an embodiment of the present disclosure.

As shown in FIG. 6, for a consumer node, a system or SCP may enable an integrated implementation including various routing policies, which may be used for deciding a particular routing of request. For example, as shown in FIG. 6, a table shows the routing based on active standby routing policy of SCP including routing between pairwise configured endpoints in active cluster and DR cluster as

[symbol]

described hereinabove. In another example, a table shows the routing based on active-active routing policy of SCP including routing between endpoints within an active cluster to ensure that all endpoints in the active cluster may be effectively utilized. In another example, a table shows the routing based on primary-secondary routing policy of SCP including routing between endpoints within primary and [symbol] [symbol]
secondary clusters, wherein primary cluster may be used in priority over secondary cluster such that only upon verifying that all primary clusters are unavailable, [symbol] [symbol]
endpoints in secondary cluster may be used for routing. In another example, a table shows the routing based on hybrid primary-secondary routing policy of SCP including routing between endpoints within primary and secondary clusters, based on active and standby modes.

In an embodiment, the NF Instance represents a single instance of network function of 5G core network (5GCN). Further, a group of NF instances makes a NF SET ID and a group of NF SET or even a single NF SET may form a cluster.

In an embodiment, when a traffic is coming to a cluster the cluster becomes active. A cluster DR may be used when the active cluster may go down when the traffic is approaching the cluster DR.

In an embodiment, SCP proxy (602) may be either ingress proxy or egress proxy. The Ingress proxy instance ensures incoming traffic for producer NF based on configured policy default is round robin.

In an embodiment, Egress proxy ensures consumer's outgoing traffic flow to a right SCP ingress proxy, and routing based on NF or SCP selection criteria.

In an embodiment, NF Instance Id's may be mapped to their corresponding destination IpEndPoints through a cache data (604).

In an embodiment, the PLMN Id and Context Id wise are mapped to their corresponding destination IpEndPoints through a cache data (606) and cache data (610).

In an embodiment, the NF Set Id wise may be mapped to their corresponding destination IpEndPoints through a cache data (608).

In an embodiment, the NF Consumer (612) may be consuming service of producer NF.

In an embodiment, the NF Consumer (612) may send request to a SCP proxy (602) and The SCP proxy (602) may route request using the cache data mapping.

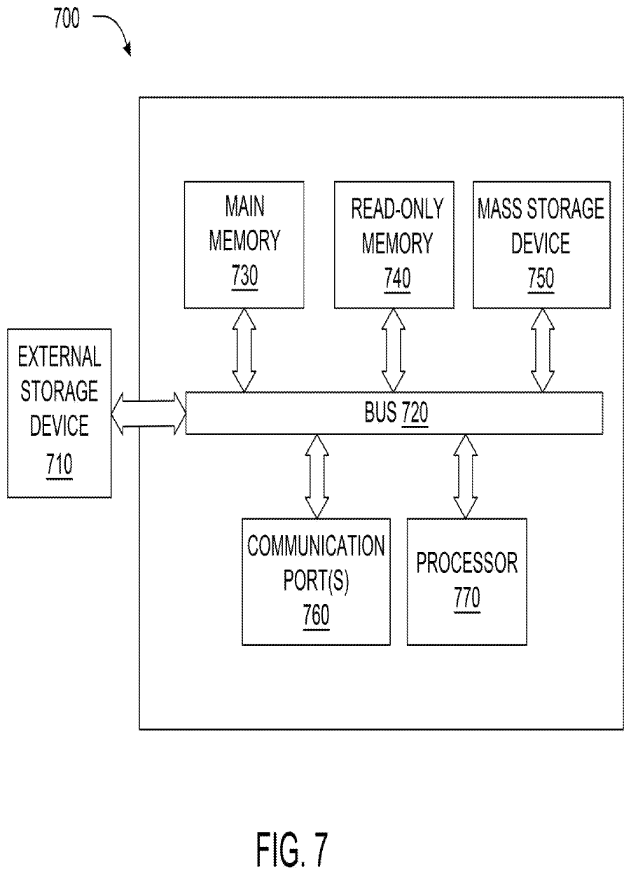

Referring FIG. 7, an exemplary computer system 700 in which or with which embodiments of the present disclosure may be utilized, is disclosed. As shown in FIG. 7, the computer system 700 may include an external storage device 710, a bus 720, a main memory 730, a read-only memory 740, a mass storage device 750, one or more communication ports 760, and a processor 770. A person skilled in the art will appreciate that the computer system 700 may include more than one

[symbol]

processor and/or communication ports. The processor 770 may include various modules associated with embodiments of the present disclosure. The one or more communication ports 760 may be any of an RS-232 port for use with a modem-based dialup connection, a 10/100 Ethernet port, a Gigabit or 10 Gigabit port using copper or fiber, a serial port, a parallel port, or other existing or future ports. The [symbol]
one or more communication ports 760 may be chosen depending on a network, such a Local Area Network (LAN), Wide Area Network (WAN), or any network to which the computer system 700 connects. The main memory 730 may be a RAM, or any other dynamic storage device commonly known in the art. The read-only memory 740 may be any static storage device(s) including, but not limited to, a [symbol]
Programmable Read Only Memory (PROM) chips for storing static information e.g., start-up or basic input/output system (BIOS) instructions for the processor 770. The mass storage device 750 may be any current or future mass storage solution, which may be used to store information and/or instructions. The bus 720 communicatively couples the processor 770 with the

other memory, storage, and communication blocks. The bus 720 can be, e.g., a Peripheral Component Interconnect (PCI)/PCI Extended (PCI-X) bus, Small Computer System Interface (SCSI), universal serial bus (USB), or the like, for connecting expansion cards, drives, and other subsystems as well as other buses, such a front side bus (FSB), which connects the processor 770 to the computer system 700.

Optionally, operator and administrative interfaces, e.g., a display, keyboard, and a cursor control device, may also be coupled to the bus 720 to support direct operator interaction with the computer system 700. Other operator and administrative interfaces may be provided through network connections connected

[symbol]

[symbol]

through the one or more communication ports 760. In no way should the [symbol] [symbol]
aforementioned exemplary computer system 700 limit the scope of the present disclosure.

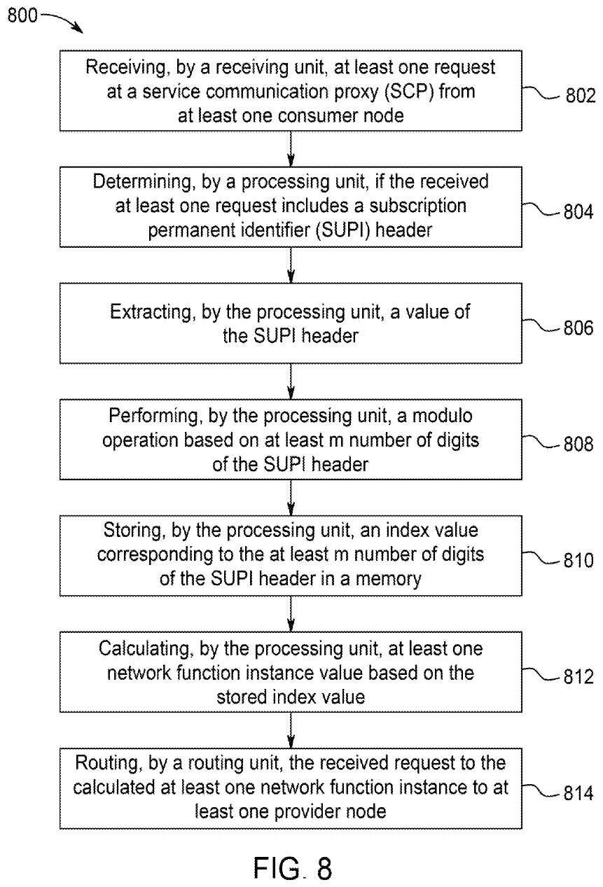

FIG. 8 illustrates an exemplary flow diagram for a method for routing subscriber traffic in a wireless network.

At step 802, the method comprising receiving, by a receiving unit (212), at least one request at a service communication proxy (SCP) (204) from at least one consumer node.

At step 804, the method comprising determining, by a processing unit (210), if the received at least one request includes a subscription permanent identifier (SUPI) header.

At step 806, the method comprising extracting, by the processing unit (210), a value of the SUPI header. The SUPI header includes a plurality of digits.

At step 808, the method comprising performing, by the processing unit (210), a modulo operation based on at least m number of digits of the SUPI header.

At step 810, the method comprising storing, by the processing unit (210), an index value corresponding to the at least m number of digits of the SUPI header in a memory (206).

At step 812, the method comprising calculating, by the processing unit (210), at least one network function instance value based on the stored index value.

At step 814, the method comprising routing, by a routing unit (216), the received request to the calculated at least one network function instance to at

[symbol]

least one provider node.

In an aspect, the proposed system and method may enable optimized routing of data and/or information exchange between various network functions, thereby avoiding data hampering, data loss, and data misplacement. This facilitates management of subscriber traffic pertaining to incoming requests by enabling

[symbol]

[symbol]

effective and improved routing of the subscriber traffic, especially in 5G.

[symbol]

The present disclosure is configured to be employed in a 5G network and provides reduced memory space and usage, optimization of network resources, and no redundancy of sessions for a single SUPI. Thus, the present invention helps in enhanced processing speeds for incoming subscriber traffic in the network.

A person of ordinary skill in the art will appreciate that these are mere examples, and in no way, limit the scope of the present disclosure.

While considerable emphasis has been placed herein on the preferred embodiments, it will be appreciated that many embodiments can be made and that many changes can be made in the preferred embodiments without departing from

[symbol]

the principles of the disclosure. These and other changes in the preferred embodiments of the disclosure will be apparent to those skilled in the art from the disclosure herein, whereby it is to be distinctly understood that the foregoing descriptive matter to be implemented merely as illustrative of the disclosure and not as limitation.

### Advantages of the Present Disclosure

The present disclosure provides a system and a method for routing subscriber traffic from user equipment(s) in a network.

The present disclosure provides a system and a method for routing subscriber traffic with no redundancy of sessions for a single Subscription Permanent Identifier (SUPI) or a subscriber.

The present disclosure provides a system and a method for routing subscriber traffic in a network with reduced memory space and usage.

The present disclosure provides an improved user experience by providing fast and secured data interaction in a network.

The present disclosure provides a system and a method that automatically improves the optimization of resources in a network.

The present disclosure facilitates enhanced processing speeds for incoming subscriber traffic in a network.

We claim:

1. A method for routing subscriber traffic in a wireless network, the method comprising:
receiving, by a receiving unit (212), at least one request at a service communication proxy (SCP) (204) from at least one consumer node;
determining, by a processing unit (210), if the received at least one request includes a subscription permanent identifier (SUPI) header;
extracting, by the processing unit (210), a value of the SUPI header, wherein the SUPI header includes a plurality of digits;
performing, by the processing unit (210), a modulo operation based on at least m number of digits of the SUPI header;
storing, by the processing unit (210), an index value corresponding to the at least m number of digits of the SUPI header in a memory (206);
calculating, by the processing unit (210), at least one network function instance value based on the stored index value; and
routing, by a routing unit (216), the received request to the calculated at least one network function instance to at least one provider node.

2. The method as claimed in claim 1, wherein the modulo operation includes a precomputed modulo value stored in the memory (206).

3. The method as claimed in claim 1, wherein the index value is generated based on the modulo operation.

4. The method as claimed in claim 1, wherein a size of modulo (n) of the modulo operation is a number of the calculated network function instances.

5. The method as claimed in claim 1, wherein the at least m number of digits of the SUPI header are configurable by a user.

6. A system for routing subscriber traffic in a wireless network, the system comprising:
a receiving unit (212) configured to receive at least one request at a service communication proxy (SCP) from at least one consumer node;
a processing unit (210) configured to:
determine if the received at least one request includes a subscription permanent identifier (SUPI) header;
extract a value of the SUPI header, wherein the SUPI header includes a plurality of digits;
perform a modulo operation based on at least m number of digits of the SUPI header;
store an index value corresponding to the at least m number of digits of the SUPI header in a memory (206);
calculate at least one network function instance value based on the stored index value; and
a routing unit (216) configured to route the received request to the calculated at least one network function instance to at least one provider node.

7. The system as claimed in claim 6, wherein the modulo operation includes a precomputed modulo value stored in the memory (206).

8. The system as claimed in claim 6, wherein the index value is generated based on the modulo operation.

9. The system as claimed in claim 6, wherein a size of modulo (n) of the modulo operation is the number of the calculated network function instances.

10. The system as claimed in claim 6, wherein the at least m number of digits of the SUPI header are configurable by a user.

11. A wireless network comprising a system for routing subscriber traffic, the system comprising:
a receiving unit (212) configured to receive at least one request at a service communication proxy (SCP) from at least one consumer node;
a processing unit (210) configured to:
determine if the received at least one request includes a subscription permanent identifier (SUPI) header;
extract a value of the SUPI header, wherein the SUPI header includes a plurality of digits;
perform a modulo operation based on at least m number of digits of the SUPI header;
store an index value corresponding to the at least m number of digits of the SUPI header in a memory (206);
calculate at least one network function instance value based on the stored index value; and
a routing unit (216) configured to route the received request to the calculated at least one network function instance to at least one provider node.

12. The wireless network as claimed in claim 11, wherein the modulo operation includes a precomputed modulo value stored in the memory (206).

13. The wireless network as claimed in claim 11, wherein the index value is generated based on the modulo operation.

14. A computer program product comprising a non-transitory computer-readable medium comprising instructions that, when executed by one or more processors, cause the one or more processors to perform a method for routing subscriber traffic in a wireless network, the method comprising:
receiving at least one request at a service communication proxy (SCP) (204) from at least one consumer node;
determining if the received at least one request includes a subscription permanent identifier (SUPI) header; [symbol]
extracting a value of the SUPI header, wherein the SUPI header includes a plurality of digits;
performing a modulo operation based on at least m number of digits of the SUPI header;
storing an index value corresponding to the at least m number of digits of the SUPI header in a memory (206);
calculating at least one network function instance value based on the stored index value; and
routing the received request to the calculated at least one network function instance to at least one provider node.
